(19) United States
(12) Patent Application Publication
(10) Pub. No.: US 2008/0042507 A1
(43) Pub. Date: Feb. 21, 2008

(54) Turbine starter-generator

(76) Inventor: Jonathan Sidney Edelson, Portland, OR (US)

Correspondence Address: BOREALIS TECHNICAL LIMITED, 23545 NW SKYLINE BLVD, NORTH PLAINS, OR, 97133-9204, US

(21) Appl. No.: 11/974,399

(22) Filed: Oct. 12, 2007

Related U.S. Application Data
(63) Continuation-in-part of application No. 11/900,614, filed on Sep. 11, 2007.
(63) Continuation-in-part of application No. 11/517,086, filed on Sep. 6, 2006.
Application No. 11/900,614 is a continuation-in-part of application No. 11/792,967.
Application No. 11/900,614 is a continuation-in-part of application No. 11/630,293.
Application No. PCT/US05/45409 is a continuation-in-part of application No. 11/029,978, filed on Jan. 4, 2005, now Pat. No. 7,116,019.
Application No. 11/029,978 is a division of application No. 10/132,936, filed on Apr. 26, 2002, now Pat. No. 6,838,791.
Application No. 11/029,978 is a continuation-in-part of application No. 09/713,654, filed on Nov. 15, 2000, now Pat. No. 6,657,334.
Application No. 11/900,614 is a continuation-in-part of application No. 11/587,348, filed on Oct. 24, 2006.
(60) Provisional application No. 60/843,930, filed on Sep. 11, 2006.
(60) Provisional application No. 60/714,603, filed on Sep. 7, 2005.
(60) Provisional application No. 60/737,587, filed on Nov. 16, 2005.
(60) Provisional application No. 60/635,767, filed on Dec. 13, 2004.
(60) Provisional application No. 60/737,587, filed on Nov. 16, 2005.
(60) Provisional application No. 60/581,789, filed on Jun. 21, 2004.
(60) Provisional application No. 60/286,862, filed on Apr. 26, 2001.
(60) Provisional application No. 60/565,802, filed on Apr. 26, 2004.
(60) Provisional application No. 60/851,404, filed on Oct. 13, 2006.

(51) Int. Cl. H02K 19/00; H02K 3/00; H02K 1/00

(52) U.S. Cl. 310/164; 310/179; 310/216; 310/254

(57) ABSTRACT

The invention consists of a ring motor, in which a first ring forms a toroidally wound stator and a second ring forms the rotor. A turbine is fixed to the rotor ring. The invention is specifically targeted towards the environment inside a gas turbine, in which hot gases may permeate the space between rotor and stator.

### CROSS-REFERENCE TO RELATED APPLICATIONS

This application claims the benefit of U.S. Provisional Patent Application No. 60/851,404, filed Oct. 13, 2006. This application is a Continuation-in-Part of U.S. patent application Ser. No. 11/900,614, filed Sep. 11, 2007, which claims the benefit of U.S. Provisional Patent Application No. 60/843,930, filed Sep. 11, 2006, and is a Continuation-in-Part of U.S. patent application Ser. No. 11/517,086, filed Sep. 6, 2006, which claims the benefit of: Provisional Patent Application No. 60/714,603, filed Sep. 7, 2005; Provisional Patent Application No. 60/737,587, filed Nov. 16, 2005; and International Application No. PCT/US2005/045409, filed Dec. 13, 2005. patent application Ser. No. 11/900,614 is also a Continuation-in-Part of U.S. patent application Ser. No. 11/792,967, filed Jun. 13, 2007, which is the U.S. National Stage Application of International Application No. PCT/US2005/045409, filed Dec. 13, 2005, which International Application was published on Jun. 22, 2006, as International Publication WO/2006/065988 in the English language. The International Application claims the benefit of U.S. Provisional Patent Application No. 60/635,767, filed Dec. 13, 2004, and U.S. Provisional Patent Application No. 60/737,587, filed Nov. 16, 2005. patent application Ser. No. 11/900,614 is also a Continuation-is-Part of U.S. patent application Ser. No. 11/630,293, filed Dec. 19, 2006, which is the U.S. National Stage Application of International Application No. PCT/US2005/022011, filed Jun. 21, 2005, which International Application was published on Jan. 5, 2006, as International Publication WO2006/002207 in the English language. The International Application claims the benefit of Provisional Patent Application No. 60/581,789, filed Jun. 21, 2004 and is a Continuation-in-Part of U.S. patent application Ser. No. 11/029,978, filed Jan. 4, 2005, which is a Divisional of U.S. patent application Ser. No. 10/132,936 filed Apr. 26, 2002, and which claims the benefit of U.S. Provisional Application No. 60/286,862 filed Apr. 26, 2001. U.S. patent application Ser. No. 10/132,936 is a Continuation-in-Part of U.S. patent application Ser. No. 09/713,654, filed Nov. 15, 2000. patent application Ser. No. 11/900,614 is also a Continuation-in-Part of U.S. patent application Ser. No. 11/587,348, filed Oct. 24, 2006, which is the U.S. National Stage Application of International Application PCT/US2005/013748, filed Apr. 22, 2005, which International Application was published on Nov. 10, 2005, as International Publication WO2005/107036 in the English language. The International Application claims the benefit of Provisional Patent Application No. 60/565,802, filed Apr. 26, 2004.

These documents are hereby incorporated herein by reference in their entirety.

### BACKGROUND OF THE INVENTION

The present invention is concerned with ring motor-generator systems, and is more especially directed to a gas turbine electric starter.

Use of ducted propellers for use as thrusters, water-jets etc on ships is well known. In one configuration, these are mounted on pylons with gearboxes in the hub of the pylon, and drive being supplied by an external motor via a drive shaft.

According to Final Report and Recommendations to the 24th International Towing Tank Conference (ITTC), in a paper entitled “The Propulsion Committee”, there has been a growing interest in developing the applications of the rim-driven (or tip-driven) propeller concept. In this concept, a permanent magnet ring (or band) is attached to the propeller tip and the motor stator is integrated into a surrounding duct whereby the propeller is driven from the blade tips. The ring (or band) is recessed inside the duct with a small water filled gap between the band and the duct. Current proposed applications include propulsors, thrusters and water-jets.

The paper: “Scale Model Testing of a Commercial Rim-Driven Propulsor Pod”, by Lea et al., published by SNAME in the “Journal of Ship Production”, Volume 19, Number 2, 1 May 2003, pp. 121-130(10), incorporates the following Abstract: Podded propulsion is gaining more widespread use in the marine industry and is prevalent in newer cruise ships in particular. This propulsion system can provide many advantages to the ship owner that include increased propulsion efficiency, arrangement flexibility, payload, and harbor maneuverability. A new, unique podded propulsor concept is being developed that allows optimization of each element of the system. The concept comprises a ducted, multiple-blade row propulsor with a permanent magnet, radial field motor rotor mounted on the tips of the propulsor rotor blades, and the motor stator mounted within the duct of the propulsor. This concept, designated a commercial rim-driven propulsor pod (CRDP), when compared to a conventional hub-driven pod (HDP), offers improved performance in a number of areas, including equal or improved efficiency, cavitation, and hull unsteady pressures. The combination of these CRDP performance parameters allows the ship designer much greater flexibility to provide improved ship performance as compared to that of an HDP. A CRDP is being developed to power a panama-size cruise vessel. The paper addresses the hydrodynamic performance of that CRDP design demonstrated at 1/25th scale as tested at the Hamburg Ship Model Basin, Hamburg Germany (HSVA).

Van Blarcom et al. (2004) describe the design of a rim-driven propulsor. The concept is comprised of a ducted multiple blade row propulsor with a permanent magnet radial flux motor rotor mounted at the tips of the propulsor blades and the motor stator mounted within the duct. The rotor shaft and bearings are housed in a relatively small hub, which is free flooding and supported by a set of downstream stator blades.

U.S. Pat. No. 6,837,757 to Van Dine et al. is directed to a rim-driven propulsion pod arrangement. In the embodiments described in the specification, a rim-driven propulsion pod arrangement has a cylindrical housing with a duct providing a flow path for water and a rotor assembly supported from a central shaft and containing a rotating blade row and driven by a rim drive permanent magnet motor recessed in the housing. An array of vanes downstream from the rotating blade row is arranged to straighten the flow of water emerging from the rotating blade row. Radial bearing members on the rotor have a hardness less than that of the shaft on which the rotor is supported and relatively soft protrusions are provided in the space between the rotor and the housing to limit excursion of the rotor. A thrust bearing has wedges arranged to form a water wedge between facing surfaces of the rotor and the rotor support during rotation of the rotor.

U.S. Pat. No. 6,152,791 to Sinko et al. is directed to an external electric drive propulsion module arrangement for swath vessels. In the embodiments described in the specification, a SWATH vessel has a superstructure supported by strut members from a pair of pontoons and each pontoon has a propulsion module removably attached to the rear end of the pontoon. The propulsion module has a self contained propulsion system including a module body with a longitudinal water passage, a rim drive electric motor, a row of rotatable blades, and an inlet opening at the forward end of he cowl member which is arranged to draw in the boundary layer of water flowing along the pontoon to which the propulsion module is attached. Spaced vanes are provided at the inlet opening to block objects from being drawn into the longitudinal passage.

U.S. Pat. No. 5,967,749 to Eaves et al. is directed to a controllable pitch propeller arrangement. In the particular embodiments described in the specification, a controllable pitch propeller arrangement includes a plurality of propeller blades supported from a central hub which is rotatably mounted on a shaft in which each blade is pivotally supported from the central hub. Two radial pins extending from the outer ends of each of the blades are received in corresponding rims having peripherally disposed permanent magnet arrays. The rims are rotated to drive the propeller by energizing the coils in a stator assembly surrounding the rims and the pitch of the blades is changed by changing the phase relationship of the current supplied to the stator coils to change the angular relation of the rims.

U.S. Pat. No. 6,956,310 to Knox is directed to a submersible pump motor having rotor sections spaced apart from each other with bearings located between. The bearings support the shaft of the rotor within a stator. The bearing is stationary and has a cavity in its outer periphery. A metallic coiled member is positioned along the circumference of the bearing, and rests in the cavity on the outside diameter of the bearing. The coiled member engages the bearing and the inner wall of the stator to prevent rotation of the bearing.

A substantial drawback of rim driven propellers in the prior art is that they all require permanent magnets.

There is currently much interest in replacing hydraulic start in gas turbines with some form of electric start, in particular for a design that would serve as a ‘drop in replacement’ for the current hydraulic starter systems. In these systems, the hydraulic starter is typically coupled to the gas turbine engine via a reduction gearbox, which reduces the speed required of the starter, but increases the torque requirement. Additionally the reduction gearbox may represent an otherwise unnecessary complication to the entire system, unless needed for the mechanical output to the particular load being serviced.

### BRIEF SUMMARY OF THE INVENTION

The present invention is a high speed electric motor directly coupled to a gas turbine high pressure (HP) or intermediate pressure (IP) shaft, eliminating several gear interfaces, several high speed bearings, the lubrication and support infrastructure associated with these bearings and gears, and the weight of all of these components. The electric motor is typically integrated with turbine components of the intake compressor, and utilizes the bearings and support structure of the engine HP or IP shaft.

The motor is a ring induction motor, having a stator exterior to a ring rotor. The ring rotor has an internal diameter equal to the outside diameter of the turbine. The outer tips of the turbine are attached to the inner surface of the rotor ring.

In a preferred embodiment, the invention consists of a ring motor, in which a first ring forms a toroidally wound stator and a second ring forms the rotor. A turbine is fixed to the rotor ring. The invention is specifically targeted towards the environment inside a gas turbine, in which hot gases may permeate the space between rotor and stator. To protect them, the rotor and stator are individually potted in multi-layer epoxy. This protects the electrical insulation from breakdown.

The turbine preferably spins with the rotor, with or without gearing, and is mounted on a central shaft with sealed bearings. For support, the drive shaft may be connected to the stator with support means, for example a series of struts mounted on both the front and/or back of the stator. The rotor is preferably solid metal, with magnetic materials enclosed or ‘canned’ in suitable high temperature alloys. The stator may be sealed with materials other than epoxy, and may also be ‘canned’. Said gearing may be planet gears, eccentric gears, or any appropriate gearing.

In a preferred embodiment, the stator has more than three different phases per pole, and preferably many more. Electronic means may be used for providing current of a variety of harmonic orders lower than the phase count, particularly to saturate the air-gap and increase the flux in the region. Also, harmonics may be used to vary the machine impedance. If the stator is connected mesh, and/or if the stator is wound so that repeated phases in different poles each receive dedicated drive, for example, a separate inverter leg supplies each phase, as opposed to an inversion of one phase supplying a second phase, further options exist. For example, the voltage to the phases may be moderated to control the rotor alignment relative to the stator.

The AC motor is expected to take the form of a ring stator and rotor, with a low stator/rotor length to diameter ratio, and a high phase count.

### BRIEF DESCRIPTION OF THE SEVERAL VIEWS OF THE DRAWING

FIG. 1 shows a general design layout;

FIG. 2 shows a schematic of a toroidal winding;

FIG. 3 shows a typical stator/rotor pair with lamination schematic; and

FIG. 4 shows a dual rotor embodiment.

### DETAILED DESCRIPTION OF THE INVENTION

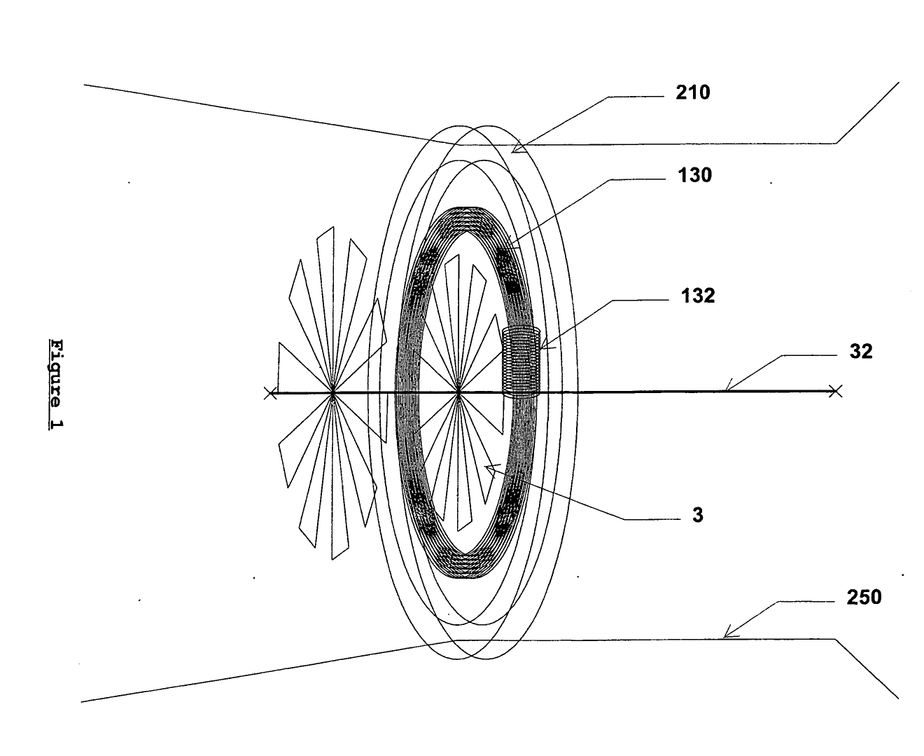

Referring now to FIG. 1, the present invention comprises an integral “ring induction motor” at the outside edge of the turbine blades.

Such a ‘ring motor’ would be integrated to the periphery of the compressor section of the turbine, without impeding airflow. Such a motor would easily produce the necessary torque to both purge and start the turbine, and could then be used as a generator to provide electrical power to auxiliary and parasitic loads. Current densities are so low as to permit air-cooling of the motor, and flux densities are low enough to permit the use of conventional magnetic alloys, or alloys selected for mechanical rather than magnetic properties.

The stator 210 is toroidal and encircles the ring rotor 130 and is integrated in the turbine housing 250.

The rotor toroid 130 is preferably constructed using steel wire wrapped to form the bulk of the magnetic material, but may also be constructed using lamination stock. The end rings are preferably steel reinforced copper, and may also be constructed by using wire. The rotor ‘slots’ and ‘teeth’ are preferably built by wrapping copper and steel wire around the ring in the poloidal direction. The complete motor apparatus is preferably enclosed in housing and subjected to Hot Isostatic Processing to form a solid mass with the necessary electromagnetic properties. This is adequate for an average turbine spinning at 5000 to 25000 RPM, for example but without limitation.

Preferably, conventional steels are used. The flux density in the steel is expected to be in the 1.2-1.4 Tesla range. The bearings required for such an arrangement are the same as those needed to enable the existing turbine to spin. The motor is preferably mounted on one of the turbine blade sets. An advantage of the invention is therefore that no extra bearings need to be added; the turbine must have the necessary bearings in order to be able to spin.

Referring now to FIG. 1, which shows the electric starter generator of the present invention mounted inside a turbine housing 250, and comprises a first and a second ring, forming the stator 210 and the rotor 130. The rotor laminations are preferably thick enough to carry all of the flux. The tips of turbine blade 3 are fixed to the inside surface of rotor 130, so that the rotation of rotor 130 provides direct drive to turbine blade 3. A benefit of the ring design is that the entire rotor circumference is involved in mechanical power production.

The gap between rotor 130 and stator 210 is quite large by electrical machine standards, in order to provide space for protective material 5 within the gap. It is important that protective material 5 is permeable to the magnetic field generated. In a preferred embodiment, protective material 5 is multi-layer epoxy, high electrical resistance stainless steel, refractory ceramics or the equivalent. Typically the air-gap is in the range of 4-10 mm.

Turbine blade 3 spins with rotor 130, and is mounted on a central shaft 32, which is the gas turbine main shaft with sealed bearings.

In a preferred embodiment, conventional M19 steel is used for the stator, since the magnetic flux densities are limited by the extremely large air-gap. In a further embodiment, the stator teeth are formed relatively narrow and the stator slots relatively wide, since the total flux is low and therefore it is desirable to have space for additional copper stator windings over what would be commonplace for a conventional motor. In one embodiment, the stator slots are substantially wider than the stator teeth.

In a preferred embodiment, stator 210 is wound with a toroidal winding.

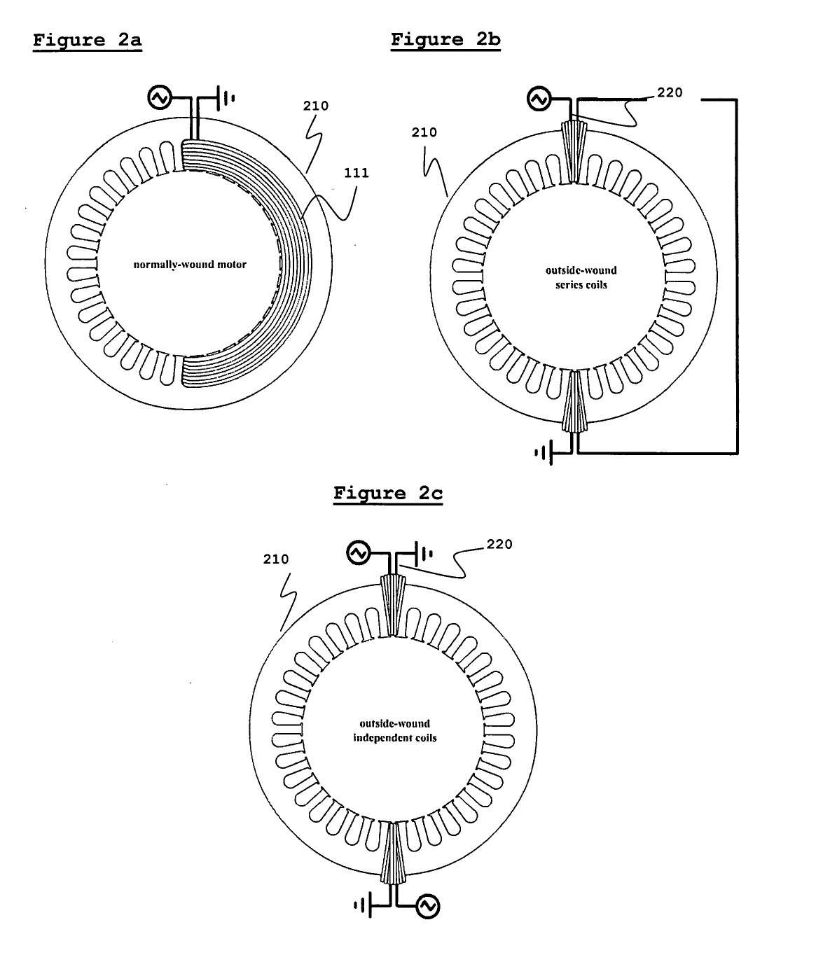

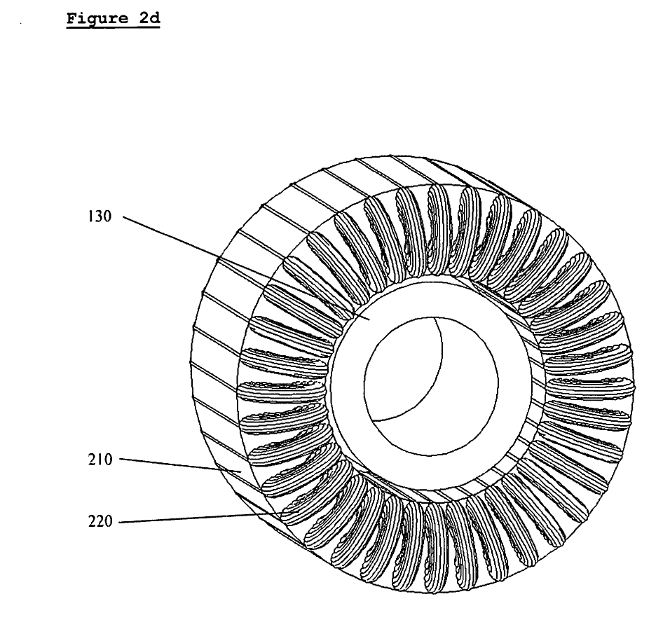

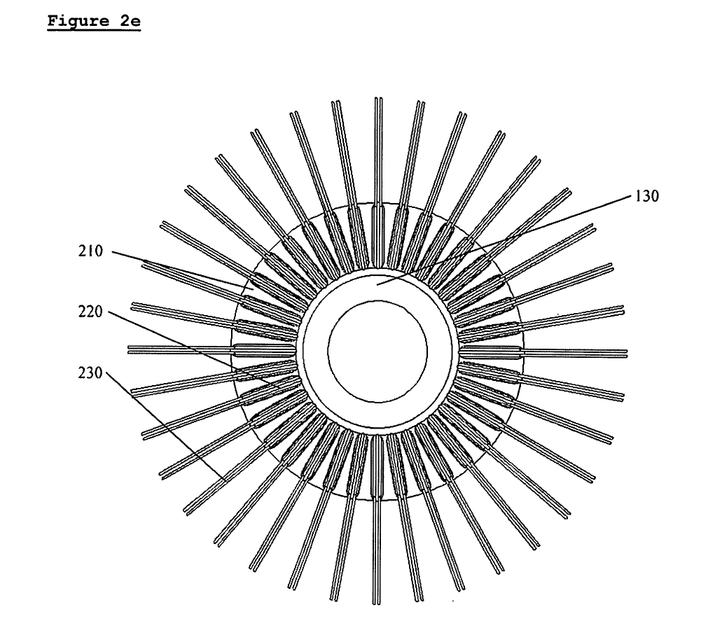

FIGS. 2a-e show possible winding designs of the motor of the present invention. With reference now to FIG. 2a, an end view of one of the windings of a prior art, normally wound, 2 pole stator is shown. The winding is composed of multiple conductor turns 111, placed in two slots on opposite sides of the stator. The conductor turns form a loop around the two sides on the stator via end turns as shown. As will be readily appreciated, these end turns comprise a more-or-less large proportion of the total conductor length used, depending on the relative length and diameter of the stator. This represents a full span winding. Short pitch winding are often used to reduce the problems with end turns, but they introduce their own costs.

FIG. 2b shows a schematic for the toroidal winding. The toroidal winding may be described as an outside-wound stator, in which the conductor forms a loop 220, not via end turns as in the prior art, but via the outside of the stator. Assuming the stator is shaped like a hollow cylinder, each coil is wound down an internal wall of the cylinder, across the bottom cylinder wall, back up the corresponding outside wall of the cylinder, and across the top cylinder wall. The rotor is internal to the stator, and only the portion of the coil that is internal to the stator cylinder is active. A large number of coils are placed around the stator circumference. FIG. 2b is simplified to show only two coils. These are connected in series, in a two pole configuration, as is commonly employed.

With reference now to FIG. 2c, a toroidal wrapped motor is shown, in which coils are each independently driven.

With reference now to FIG. 2d, a fully wound view of stator 210 is provided. Stator 210 is equipped with slots on the inside and out. Rotor 130 is internal to stator 210. 36 coils 220 are individually wrapped around stator 210. Wrapping the coil around the outside of the stator in this fashion provides a design that is easier to wind, can have excellent phase separation, and allows independent control of the current in each slot. This eliminates many cross stator symmetry requirements.

With reference now to FIG. 2e, a stator equivalent to FIG. 2d is shown, with two terminals 230 shown for each coil. Terminals 230 may be connected in series or parallel to other coils, and are driven by inverter outputs.

The value of the design depends on stator length and circumference, and winding configurations. These determine how much of the conductor coils are unused in active power production. In conventional stator designs, the unused conductor is generally in the ‘end turn’ length. For example, in a large, conventional two pole machine, in which the end turns must each cross the stator diameter, the amount of wire wasted as end turns is far longer than the wires actively used in the slots. For example, a 2 pole machine having a slot length of 4.5 inches and a mean turn length on the order of 40 inches, has 75% of the wire in the ‘end turn’, and the end turn is very bulky, requiring a shorter lamination stack. In contrast, by using the toroidal winding, the unused conductor will be shortened considerably. This is the case even though the ‘back half’ of each coil, that part on the outside of the stator, is not used, since in many designs the back side of the coils is considerably shorter than the ‘end turns’.

It is significant to note that the relative change in unused conductor length is not caused only by the number of poles, but instead by the ratio of pole size to slot length. For example, with ‘pancake’ machines with short slot length, the toroidal winding will result in a shorter end turn even for machines of high pole count. In general, the following design features will be most advantageously suited to the toroidal winding of the present invention: low pole count, short slot length, long pole span (circumference), and large diameter. The particular configuration for any particular design will depend upon all of these factors and these suggested features are not intended to be limiting.

When a conductor is wound in a stator, each turn of the conductor through a slot will have the same voltage. This is the same for lap windings and toroidal windings. However, in a toroidal winding, each turn consists of a conductor in only one slot, as opposed to a conventional winding, in which each turn consists of two slots. Therefore, for a toroidal winding, the voltage per turn is reduced by half.

Another benefit of the toroidal design is improved slot fill. Conventional machines are built using what are known as ‘random wound’ coils where coils of wire are inserted into the slots. Partly due to the cross-stator end turn requirement, this results in a random arrangement of adjacent conductors. In a toroidal winding, the coils are formed around the stator structure. By carefully placing the wire in an ordered fashion, a pseudo ‘formed coil’ is produced. This increases the amount of conductor coil in a given volume of a stator slot, which increases the flux in the stator.

For the reasons described above, the toroidal winding is preferred since this provides a very short end turn length, and much denser packing of the wire. This is especially important in a motor design which permits only be a few turns of wire per phase per pole. It is preferable to use wire of square or rectangular cross section rather than wire of circular cross section for the stator windings, although this is not intended to be limiting.

In a preferred embodiment, each coil occupies a single slot, therefore each slot has a high number of turns of wire wrapped around the stator at that location.

The stator windings may have any number of poles. In one embodiment, the stator has a high number of poles, for example 20 or more. Preferably, a balance is struck between the size of the poles and the size of the back iron (the inactive part of the coils). An advantage of large magnetic poles is that this minimizes the magnetizing current required per pole for the non-magnetic gap between rotor and stator. A disadvantage of large poles is that the unused back iron area is larger, which reduces the efficiency of the motor. Preferably, therefore, the motor has a relatively low number of poles compared with the radius of the air-gap. Toroidally wound motors are therefore well suited to this design, since they feature a low number of poles as well as a short stack length compared with stator diameter. A non-limiting example with figures is given at the end of the specification.

In a preferred embodiment, the stator incorporates a high number of different phases per pole. A high phase count enables harmonics to be exploited instead of wasted, since all stray harmonics of harmonic order up to the phase count are harnessed to produce useful torque in the direction and at the speed of rotation. A high phase count further provides greater fault tolerance in the case of a single phase failure. A further benefit that arises from using a high number of phases is that an inverter with appropriate command electronics can be used to deliberately inject harmonics.

One particular advantage of the use of high order harmonics in the present invention is as follows: The preferred design of the toroidal stator is with narrow teeth and a large air-gap. However, this design is vulnerable to magnetic saturation of the teeth and gap area relative to the stator core. By injecting higher order harmonics according to the phase count, stator dimensions, and degree of saturation, it is possible to reduce air-gap magnetization losses and improve efficiency. One suggested formula for this would be a function of theta f(theta) that describes the air-gap flux density, where theta is the phase angle of the waveform. Any waveform can be used in which the peak flux density is reduced, and regions with lower flux density are enhanced, keeping the total flux density constant. Preferably a waveform is used which adds an appropriately phased third harmonic, as this is the simplest waveform which achieves the required effect.

For a larger motor, the number of poles and/or phases may be increased. Preferably, there are a high number of different phases per pole, for example 36 different phases per pole, or higher.

The motor windings may be connected to an inverter drive with a full bridge, or with half-bridges in a star or a mesh connection. Any of the mesh connections or the star connection may be used. Since this is mainly intended as a fan-type load with substantially no low speed high torque requirement, in a preferred embodiment the windings are connected with a star connection.

In a further preferred embodiment, each of the stator winding phases, in each pole, is independently driven by a dedicated inverter leg, enabling the machine to be operated with second harmonic. Second harmonic is prohibited when a single inverter leg is used to drive repeated and inverted phases in different poles.

In an alternative arrangement, stator is not toroidally wound but is a conventionally wound radial flux stator, with regular end turns. The end turns may be bent to follow the curve of the stator, to reduce shear drag. An advantage of this arrangement is that it is easier to construct. However, a disadvantage is that it requires a large air-gap, due to the need for epoxy potting, for ease of construction, and to reduce friction of fluids in the air-gap. A large air-gap, necessitates large pole areas which, in a conventionally wound radial flux stator, necessitate long end turn spans which would dominate the motor and make it much less efficient.

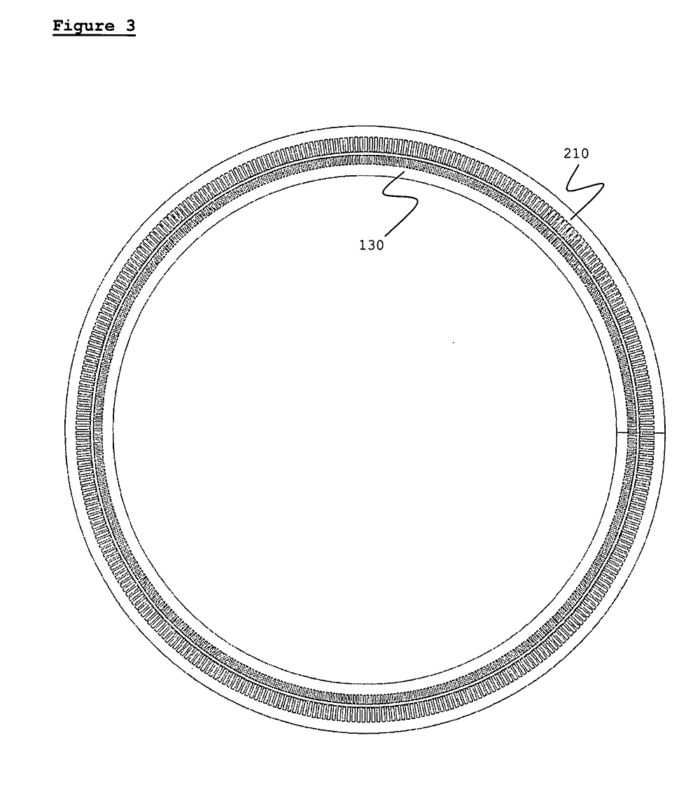

The rotor may be of any type, and in a preferred embodiment, it is a conventional copper bar squirrel cage with copper end rings. Referring now to FIG. 3, rotor 130 is shown in the form of a ring of very large diameter, and is relatively thin and short. Stator 210 is a ring of inner diameter slightly greater than the outer diameter of rotor 130. In the embodiment of FIG. 3, the stator and rotor stack lengths are substantially shorter than their diameters. There are a large number of stator and rotor teeth, preferably one per phase per slot. It is preferred to have a relatively low number of poles and a relatively high number of different phases, for example 30 different phases per pole. This diagram is simplified and does not show the turbine, but as shown in FIG. 1, turbine blade 3 is attached to the inside of ring rotor 130, and is preferably welded into place. Rotor and/or stator bearings may be active or passive.

A recommended form of active bearings is as follows. If at least one phase in at least two poles are provided with dedicated drive by an independent inverter leg, the inverter drive can provide slight variations in drive to these phases in order to actively position the rotor relative to the stator. Further details on this form of active bearings are available in WO2005/107036. In practice, this form of active alignment requires a dedicated inverter leg for at least one phase in at least two poles. Alternatively, each of the phases in each of the poles can be independently driven. As a further alternative, one phase of each pole having a particular phase angle or the inverse of that that phase angle could be independently driven.

The motor may further comprise a detector for measuring the alignment of the rotor with the stator. The detector may be any known form of position detector and may measure the position of the rotor or stator by any means, direct or indirect. Correction of misalignment is produced by the capacity of the inverter drive to produce slight variability in drive voltage/stator current pattern to one or more of the phases, so that the rotor can be pulled by the inverter to one side or the other as required according to the results from the alignment detector.

The present invention may furthermore utilize any control techniques normally used for induction motor control, including but not limited to V/Hz control, field oriented control, vector control, sensorless vector control, etc.

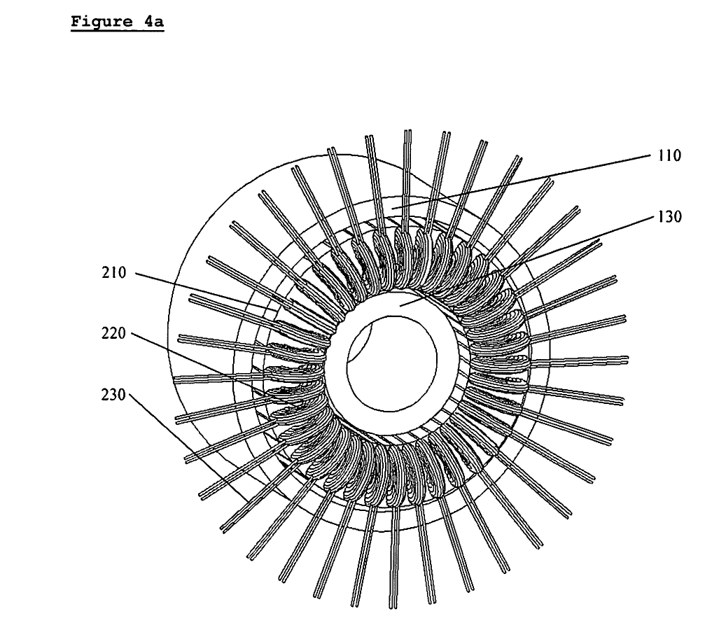

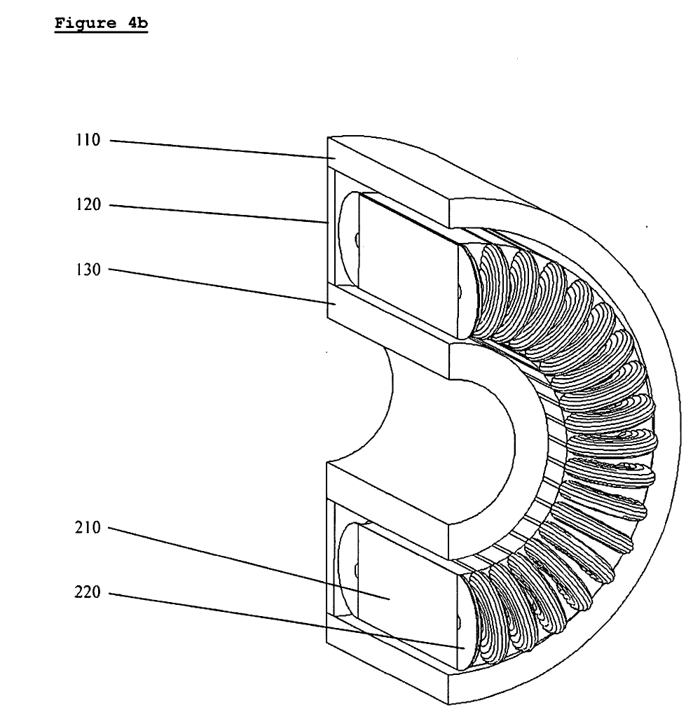

With reference now to FIG. 4a, in a further embodiment, a dual rotor is used. A first rotor is internal to the stator and a second rotor is external to the stator. Stator 210 has teeth on the inside and outside. Conducting windings 220 are wound around stator 210. External rotor 110 is external to stator 210. Internal rotor 130 is internal to stator 210. The benefit of the dual rotor is that more of the stator winding conductors are involved in active power production.

FIG. 4b shows a cutaway view of the same stator rotor combination as FIG. 4a. External rotor 110 is connected to internal rotor 130 through join 120. Join 120 is non conductive, and serves only to unite the two rotors 110 and 130, enabling them to spin in synchrony, and together provide rotational energy to a load. In addition to non-conductive join 120, said rotor may comprise a ‘U’ or ‘C’ shaped join, which may surround the stator on three sides. Note that the stator back iron would need to be as large as the rotor back iron in this arrangement.

An advantage of the dual-rotor configuration is that it enables a higher percentage of each turn of the stator windings to be active, since two faces of each stator winding turn are involved in electromechanical conversion.

The stator and rotor are not limited to being one internal to the other. In further embodiment, the stator may be an axial flux type stator. The rotor may then be situated in front of or behind the stator, instead of interior to the stator. The stator and rotor rings will therefore then have the same outer active diameter as each other. Furthermore, one rotor may be situated in front of, and one behind, the stator. This embodiment may be constructed using the same techniques as that of the first embodiment described herein. An advantage of this embodiment is that radial vibrations of the system would not cause the rotor to push into the stator across the air-gap.

### EXAMPLE

The following example is for illustration only and is not intended to be limiting. A motor of the present invention with an outer diameter of 1050 mm, inner diameter of 850 mm and a length of 50 mm, could provide a torque of 500 Newton meters, well in excess of that required to start typical gas turbines. The motor could function as a generator, conservatively providing 200 to 400 kW depending upon operating speed. The total active mass of such an electric motor would be less than 100 kg, including approximately 40 kg of mass rotating at turbine speeds. The air-gap of such a motor would be 5 mm, permitting integration with the gas friction and sealing requirements of the gas turbine.

1. A turbine motor/generator system, comprising:
(a) a stator, said stator concentric with a central shaft supporting a turbine, said stator attached to a turbine housing;
(b) a rotor, said rotor internal to said stator;
wherein one or more tips of said turbine are fixed to said rotor.

2. The system of claim 1 additionally comprising an inverter electrically connected to said stator.

3. The system of claim 2 wherein said inverter provides current of a variety of harmonic orders lower than a phase count.

4. The system of claim 2 wherein harmonics are used to vary the machine impedence.

5. The system of claim 2 further comprising at least one control technique selected from the list consisting of: V/Hz control, field oriented control, vector control, and sensorless vector control.

6. The system of claim 2 wherein said stator is toroidally wound, comprising windings wrapped around the outside and inside of said stator, and wherein each stator winding phase in each pole is independently driven by a dedicated inverter leg of said inverter.

7. The system of claim 6 further comprising means for detecting the position of said rotor with respect to said stator and means for aligning said rotor with said stator.

8. The motor of claim 6 wherein said means for aligning said rotor with said stator comprise means for varying the drive voltage to one or more of the phases.

9. The system of claim 6 wherein said stator comprises slots and teeth, and wherein said slots are substantially wider than said teeth.

10. The system of claim 6 wherein said stator is wound with flat rectangular wire.

11. The system of claim 6 wherein said stator has a substantially shorter length than diameter.

12. The system of claim 6 wherein said stator comprises more than three different phases per pole.

13. The system of claim 2 wherein said stator windings are connected to said inverter in a star connection.

14. The system of claim 2 wherein said stator windings are connected to said inverter in a mesh connection.

15. The system of claim 1 wherein said stator is designed as a conventional radial flux stator.

16. The system of claim 1 wherein said machine is axial flux, and wherein said outer and inner rings comprise substantially the same diameter.

17. The system of claim 1 wherein said generator is used for providing power.

18. The system of claim 1 wherein said motor is used for electric start of gas turbines.

19. The system of claim 1 having a gap between said stator and said rotor, wherein said gap is in the range of 4-10 mm.

20. The system of claim 1 additionally comprising a second rotor external to and concentric with said stator, wherein said rotors are joined together to rotate in synchrony.
